(19) United States
(12) Patent Application Publication
(10) Pub. No.: US 2018/0017956 A1
(43) Pub. Date: Jan. 18, 2018

(54) FABRICATING THREE DIMENSIONAL OBJECTS

(71) Applicant: Hewlett-Packard Development Company, L.P., Houston, TX (US)

(72) Inventors: Juan Manuel Garcia Reyero Vinas, Sant Cugat (ES); Sergio Puigardeu Aramendia, Barcelona (ES); Alejandro Manuel De Pena, San Cugat del Valles (ES); David Ramirez Muela, Barcelona (ES)

(21) Appl. No.: 15/545,693

(22) PCT Filed: Apr. 24, 2015
(86) PCT No.: PCT/EP2015/058926

§ 371 Date: Jul. 22, 2017

(51) Int. Cl. G05B 19/4099

(52) U.S. Cl. CPC G05B 19/4099; B29C 64/386; B33Y 50/00; G05B 2219/49007; G05B 2219/35134

(57) ABSTRACT

A method of fabricating a three dimensional object in an additive layer manufacturing process, e.g. 3D printing, wherein a three dimensional design of the three dimensional object is modelled as a plurality of three dimensional pixels or vortexes. For every pixel or vortex, at least one parameter is calculated and is used to select a setting for use when fabricating the three dimensional object. The parameter may be a speed or rate at which heat will diffuse away from the pixel or vortex, or a weighted density surrounding the pixel or vortex. The method provides higher quality fabrication of the three dimensional object.

### BACKGROUND

Additive manufacturing systems that generate three-dimensional objects on a layer by layer basis have been proposed as a potentially convenient way to produce three-dimensional objects.

The choice of high resolution three dimensional pixels, or voxels, when building a three dimensional object, and the conditions under which they will be fabricated, can have an impact on the dimensional accuracy and the mechanical properties of the resulting object.

### BRIEF DESCRIPTION OF DRAWINGS

Examples will now be described, by way of non-limiting example, with reference to the accompanying drawings, in which:

FIG. 1 is an example of a method according to the disclosure;

FIG. 2 is an example of a three dimensional object split into three dimensional pixels of variable sizes;

FIG. 3a shows an example of a three dimensional pixel within a three dimensional object;

FIG. 3b shows an example of calculating a density within a sphere of radius R centred on a three dimensional pixel;

FIG. 4 shows an example Gaussian distribution that can be applied as a weighting function when calculating the density around the three dimensional pixel in a radius R; and

FIG. 5 shows an example of an apparatus to fabricate a three dimensional object.

### DETAILED DESCRIPTION

Additive manufacturing techniques may generate a three-dimensional object through the solidification of a build material. The build material may be powder-based and the properties of generated objects may depend on the type of build material and the type of solidification mechanism used. In a number of examples of such techniques, including sintering techniques, build material is supplied in a layer-wise manner and the solidification method includes heating the layers of build material to cause melting in selected regions. In other techniques, chemical solidification methods may be used.

Additive manufacturing systems may generate objects based on structural design data. This may involve a designer generating a three-dimensional design of an object to be generated, for example using a computer aided design (CAD) application. The model may define the solid portions of the object as well as other properties, such as the colour, density and/or porosity of the solid portions.

As noted above, the choice of three dimensional pixels, or voxels, used when fabricating a three dimensional object from structural design data, such as a three dimensional design, and the conditions under which they are fabricated can have an impact, in some examples, on the accuracy and mechanical properties of the resulting object. For example, pixels are not fabricated in isolation, but are fabricated sequentially one after another and built up in layers to form a three dimensional object. Thus, the properties of each individual pixel, such as its temperature and rate of cooling, can be affected by the properties of neighbouring pixels.

In the examples described herein, a method of fabricating a three dimensional object takes into account the geometry of the three dimensional model, including but not limited to, the impact the surrounding material can have on each pixel when selecting which settings to use to fabricate which three dimensional pixels.

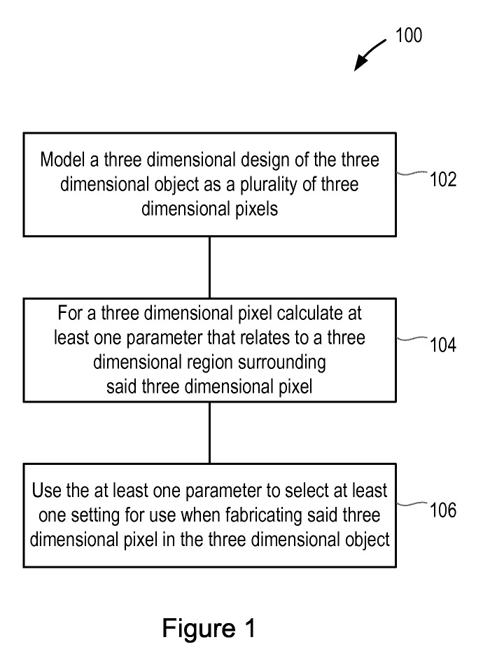

Therefore, as shown in FIG. 1, according to one example, a method of fabricating a three dimensional object (100) may comprise modelling a three dimensional design of a three dimensional object as a plurality of three dimensional pixels (102). For a three dimensional pixel, the method comprises calculating at least one parameter that relates to a three dimensional region surrounding said three dimensional pixel (104) and using the at least one parameter to select at least one setting for use when fabricating said three dimensional pixel in the three dimensional object (106).

As such, in one example the method provides a way of modifying a setting or settings of the fabrication process on a pixel by pixel or region by region basis, to take the surrounding environment of that pixel or region into consideration. For instance, pixels surrounded by large solid portions may tend to be at a higher temperature than pixels in less dense areas in a fusion-based fabrication process, and in such an example these temperature differences may be taken into consideration to optimise the build accuracy.

In some examples, modelling a three dimensional design of the three dimensional object as a plurality of three dimensional pixels (102) may comprise modelling a three dimensional design as a plurality of identical cuboid shaped three dimensional pixels (e.g. voxels). The three dimensional pixels may be at the same resolution as the resolution of the apparatus used in the subsequent fabrication process. In alternative examples the three dimensional pixels may be at a lower resolution than the resolution of the fabrication process.

In alternative examples, the plurality of three dimensional pixels may comprise pixels of different sizes. For example, it may be appropriate to model a first region of the object at a lower resolution than a second region, for example if the object properties of the first region are uniform over a large area.

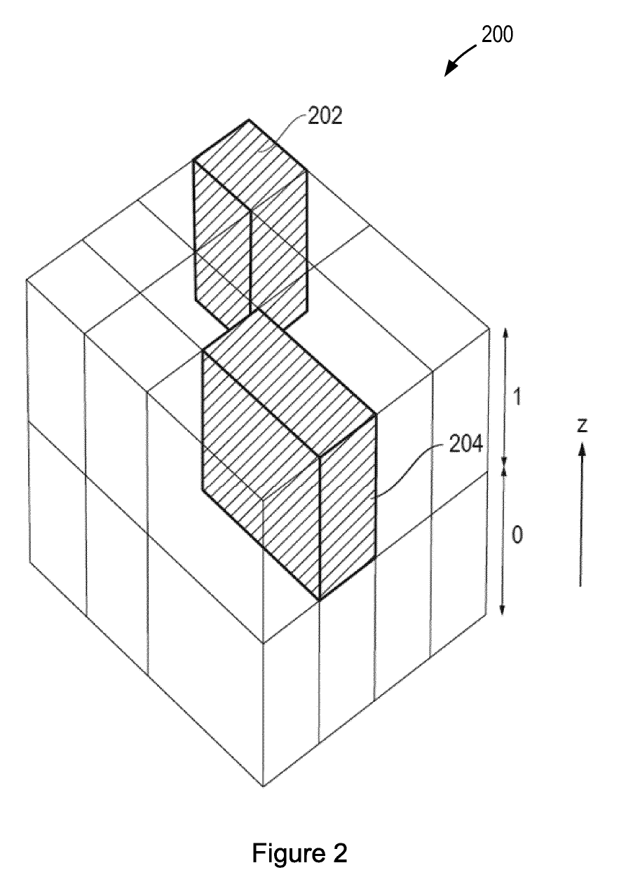

In alternative examples still, the plurality of three dimensional pixels may comprise pixels of different shapes. For instance, it may be appropriate to model an object with a mixture of cube shaped and rectangular cuboid three dimensional pixels, or three dimensional pixels of any other shape. Examples of possible three dimensional pixel configurations are shown in FIG. 2 which shows a model of a three dimensional object (200) and examples of three dimensional pixels (202) and (204) of different shapes and sizes.

The procedure of calculating, for each three dimensional pixel, at least one parameter relating to a three dimensional region surrounding said three dimensional pixel (104) may comprise calculating an n-tuple of parameters which describes the three dimensional neighbourhood of the three dimensional pixel. In one example, the choice of region or neighbourhood to use can depend upon the print material or agents being used, or the particular print process being used, or a particular parameter to be optimized, or features of the object being fabricated, or any combination thereof. For example, the procedure may involve identifying small features in the three dimensional object being formed, for example features having an area of less that 5×5 mm in a XY slice, where non fusing areas surrounding such features can influence the formation of the features, for example cooling the area which is to be fused to form the feature, which could result in such a feature not being fully fused or formed. Examples described herein enable a parameter, such as a fusing agent level, or usage of other agents, such as coalescing agents or coalescence modifier agents to be set accordingly when fabricating the three dimensional object. The region or neighbourhood of influence can differ in some examples according to other parameters, for example the operating temperature or the print process time. For example, when the temperature difference between ambient temperature and the temperature of the build material increases, in one example this can affect the choice of size of feature to use for determining which parameters to use. For example, the 5×5 mm area mentioned in the example above may be increased if the temperature difference between ambient temperature and build material temperature increases.

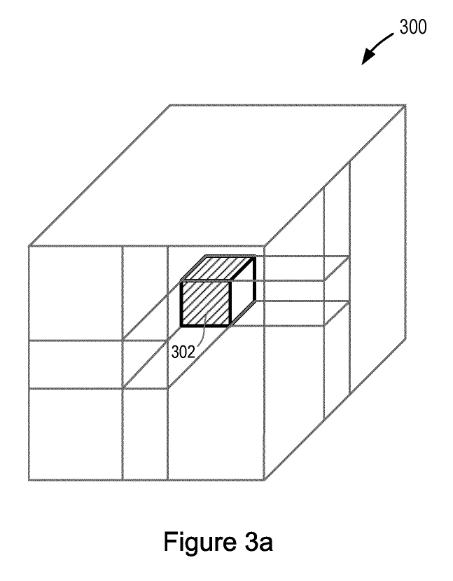

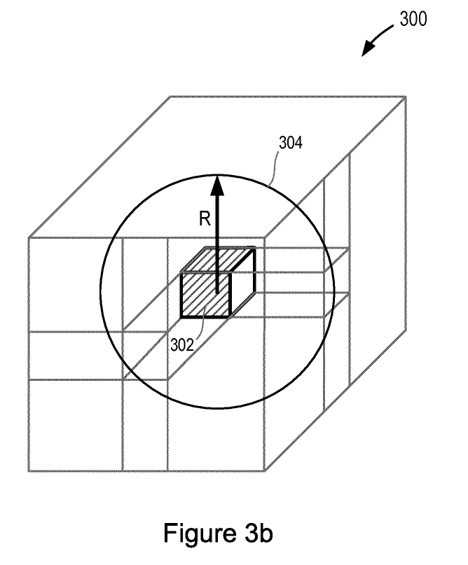

In some examples, one of the parameters may be an estimation of the density of the three dimensional region surrounding the three dimensional pixel. This may be calculated by adding up or integrating the number of three dimensional pixels in the three dimensional model in a sphere of fixed radius centred on the three dimensional pixel. This is illustrated in FIGS. 3a and 3b which show a three dimensional pixel (302) as part of a larger three dimensional object (300). In some examples, the density of the region surrounding the three dimensional pixel (302) may be calculated in a sphere of radius R, as illustrated by sphere (304).

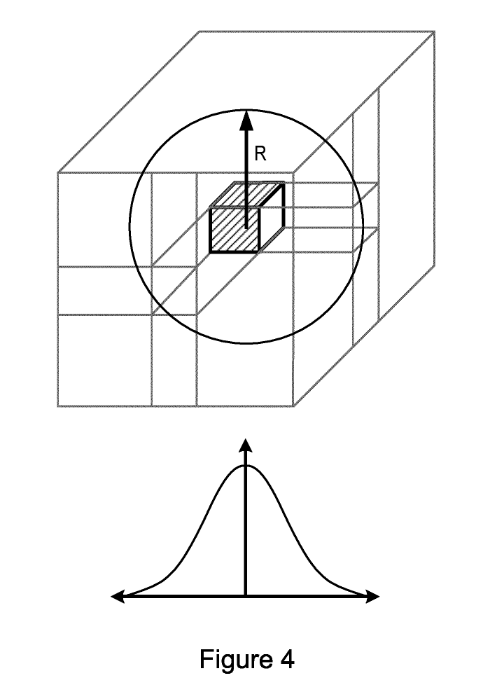

In some examples, one of the parameters may be a weighted density, calculated by integrating the mass at each value, r, from the centre of the three dimensional pixel and weighting the mass at each value of r according to a distribution that is a function of r. For example, the mass surrounding the three dimensional pixel may be weighted linearly according to the distance from the three dimensional pixel. In another example, the mass may be weighted according to a Gaussian profile. An example of this is shown in FIG. 4, where the mass at each distance, r, from the centre of the three dimensional pixel (302) is weighted according to the Gaussian function. This provides the benefit of giving less weight to the properties of pixels that are further away from, and therefore less likely to have an influence on, the three dimensional pixel in question.

In one example, a one dimensional Gaussian weight can be extrapolated by replacing the x-axis by the absolute distance to a neighbouring voxel (three dimensional pixel).

In an example, if a voxel of interest is centred on coordinates (x₀, y₀, z₀), then the Euclidian Distance from the centre of said voxel to the centre of another voxel at coordinates (x, y, z) is:

d=\sqrt{(x−x₀)²+(y−y₀)²+(z−z₀)²}

A normal or Gaussian distribution can be defined as:

$$f ( d , μ , σ ) = \frac{1}{σ \sqrt{2 π}} {e}^{- \frac{{( d - μ )}^{2}}{2 {σ}^{2}}}$$

Where μ is the mean and σ the standard deviation.

Using this distribution, a Gaussian weighted density in a sphere R around said voxel can then be calculated according to:

$$ρ ( R ) = \frac{{\int }_{0}^{R} m ( d ) f ( d , μ , σ ) dd}{\frac{4}{3} π {R}^{3}}$$

This equation considers all of the material in a sphere of radius R around the voxel. In other examples, these principles may be applied to compute a weighted density in just a portion of the sphere, for example half of a sphere. In a three dimensional printing process whereby the object is built up in layers, this would enable the density of the printed material in a radius R below the voxel, for example, to be calculated, without considering material above the voxel that has not yet been printed.

In some examples, at least one of the parameters may describe the heat flow properties of the surrounding material. For example, one parameter may be an estimation of the speed at which heat will diffuse away from the three dimensional pixel.

Examples of other possible parameters to use include the use of external sensors that measure in real time parameters such as temperature, optical density or color, distance to part boundaries, area, perimeter or a perimeter/area ratio of a XY slice.

The procedure of using the at least one parameter to select at least one setting for use when fabricating said three dimensional pixel in the three dimensional object (106) may comprise using the parameters, or n-tuple of parameters calculated in (104) to inform the selection of the fabrication strategy for the three dimensional pixel or for a region of three dimensional pixels. In some examples, determining the fabrication strategy may comprise determining the three dimensional structure selected for the fabrication of the three dimensional pixel. By three dimensional structure it is meant, for example, the mixture or ratio of agents to be used, such as the ratio of coalescing agent to coalescence modifier agent, or the type of physical structure to be fabricated, for example depending on whether the structure is a micro structure (for example a honeycomb pattern of 200×200 microns) or macro structure (for example a honeycomb structure of 50×50 mm), for example in order to be able to manage more efficiently an excess of heat.

Examples of settings that may be altered include the volumetric distribution of build materials, the physical conditions with which each three dimensional pixel may be fabricated, for example, the temperature of heating, or a combination of the above. In one example this may be achieved by a look up table.

In one example the three dimensional object to be fabricated is analyzed in stage (106) and the settings are selected so that the amount of fusing agent used is reduced by, for example, 50% when printing internal voxels. In some examples, internal voxels are identified because their distance to the surface is larger than a threshold, for example, 5 mm.

In another example, the amount of detailing agent (e.g. coalescence modifier agent) is reduced or removed when fabricating voxels where less than a certain percentage (e.g. 25%) of the voxels in a region surrounding said voxel (for example a 5×5×5 mm surrounding region), are not described as a solid part. In other examples, the amount of detailing agent (or coalescence modifier agent) is increased when fabricating voxels where the surrounding region is described as solid.

The method described above can, in some examples, provide a higher quality fabrication due to increased part accuracy. The method can further offer a more compact and computationally efficient control of the fabrication process that enables higher dimensional and mechanical property accuracy in fabricated parts. Computation efficiency can be improved, for example, in an example that works with a lower resolution image for some areas of the three dimensional object to be fabricated, because such areas are sharing the same properties or characteristics with other areas, thus simplifying the process, i.e. by reducing the number of operations due to there being less voxels to process.

In one example, calculating the at least one parameter is performed for each three dimensional pixel of the plurality of three dimensional pixels, with the at least one parameter being used to select at least one setting for use when fabricating each of said three dimensional pixels in the three dimensional object.

In another example, calculating the at least one parameter is performed for a three dimensional pixel of the plurality of three dimensional pixels, with the at least one parameter being used to select the at least one setting for use when fabricating a plurality of three dimensional pixels in a predetermined neighbourhood of said three dimensional pixel in the three dimensional object. In such an example, the parameter(s) calculated for a particular pixel can be used to control the setting(s) of a plurality or group pixels or neighbouring pixels.

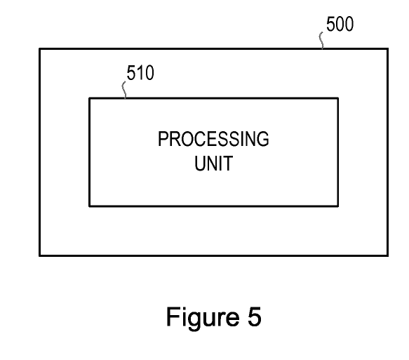

FIG. 5 shows an example of an apparatus 500 to fabricate a three dimensional object. The apparatus 500 comprises a processing unit 510 to model a three dimensional design of the three dimensional object as a plurality of three dimensional pixels. For a three dimensional pixel, the processing unit 510 calculates at least one parameter that relates to a three dimensional region surrounding said three dimensional pixel. The processing unit 510 uses the at least one parameter to select at least one settings of the apparatus when fabricating said three dimensional pixel in the three dimensional object.

In one example of an apparatus, the settings relate to the three dimensional structure selected for the three dimensional pixel.

The processing unit 510 may determine, as the at least one parameter, an estimation of the speed at which heat will diffuse away from the three dimensional pixel, and/or the density of the three dimensional region surrounding said three dimensional pixel.

In one example the processing unit 510 determines a weighted density by integrating the mass at each radius, r, from the centre of the three dimensional pixel, wherein the mass at each value of r is weighted according to a distribution that is a function of r.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method of fabricating a three dimensional object, the method comprising:
modelling a three dimensional design of the three dimensional object as a plurality of three dimensional pixels;
for a three dimensional pixel, calculating at least one parameter that relates to a three dimensional region surrounding said three dimensional pixel; and
using the at least one parameter to select at least one setting for use when fabricating said three dimensional pixel in the three dimensional object.

2. The method of claim 1 wherein one of the parameters is an estimation of the speed at which heat will diffuse away from the three dimensional pixel.

3. The method of claim 1 wherein one of the parameters is the density of the three dimensional region surrounding said three dimensional pixel.

4. The method of claim 3 wherein the density is calculated in a sphere of fixed radius centred on the centre of the three dimensional pixel.

5. The method of claim 1 wherein one of the parameters is a weighted density calculated by integrating the mass at each radius, r, from the centre of the three dimensional pixel, wherein the mass at each value of r is weighted according to a distribution that is a function of r.

6. The method of claim 5 wherein the distribution is a Gaussian distribution centred on said three dimensional pixel.

7. The method of claim 1 wherein the calculating of the at least one parameter comprises determining an n-tuple of the parameter.

8. The method of claim 1 wherein the plurality of pixels comprises pixels of different sizes.

9. The method of claim 1 wherein the plurality of pixels are at a lower resolution than the resolution of the fabrication process.

10. The method claim 1, wherein calculating the at least one parameter is performed for each three dimensional pixel of the plurality of three dimensional pixels, with the at least one parameter being used to select at least one setting for use when fabricating each of said three dimensional pixels in the three dimensional object.

11. The method of claim 1, wherein calculating the at least one parameter is performed for a three dimensional pixel of the plurality of three dimensional pixels, with the at least one parameter being used to select the at least one setting for use when fabricating a plurality of three dimensional pixels in a predetermined neighbourhood of said three dimensional pixel in the three dimensional object.

12. An apparatus to fabricate a three dimensional object, the apparatus comprising:
a processing unit to model a three dimensional design of the three dimensional object as a plurality of three dimensional pixels;
wherein for a three dimensional pixel, the processing unit calculates at least one parameter that relates to a three dimensional region surrounding said three dimensional pixel; and
wherein the processing unit uses the at least one parameter to select at least one setting of the apparatus when fabricating said three dimensional pixel in the three dimensional object.

13. The apparatus of claim 12 wherein the settings relate to the three dimensional structure selected for the three dimensional pixel.

14. The apparatus of claim 12, wherein the processing unit determines, as the at least one parameter, an estimation of the speed at which heat will diffuse away from the three dimensional pixel, and/or the density of the three dimensional region surrounding said three dimensional pixel.

15. The apparatus of claim 12, wherein the processing unit determines a weighted density by integrating the mass at each radius, r, from the centre of the three dimensional pixel, wherein the mass at each value of r is weighted according to a distribution that is a function of r.
